(19) United States
(12) Patent Application Publication
(10) Pub. No.: US 2015/0291920 A1
(43) Pub. Date: Oct. 15, 2015

(54) CLEANING INDUSTRIAL PLANT COMPONENTS TO REMOVE METAL HALIDES

(71) Applicant: WACKER CHEMIE AG, Munich (DE)

(72) Inventors: Javad MOHSSENI, Leipzig (DE); Konrad MAUTNER, Burghausen (DE); Peter NUERNBERG, Nuenchritz/OT Leckwitz (DE); Christian KALTENMARKNER, Burghausen (DE); Klaus KAEPPLER, Burghausen (DE); Andreas BOCKHOLT, Muenchen (DE)

(21) Appl. No.: 14/667,847

(22) Filed: Mar. 25, 2015

(30) Foreign Application Priority Data
Apr. 9, 2014 (DE) 10 2014 206 875.4

(51) Int. Cl. C11D 7/50; C11D 11/00

(52) U.S. Cl. CPC C11D 7/5013; C11D 11/0041; C11D 7/5009

(57) ABSTRACT

Cleaning industrial plant components to remove silane, metal halide, and organometallic halide contaminants and mixtures thereof, involves treating the plant components with a liquid nitrile or amine or mixture thereof or with a solution of a nitrile or amine or mixture thereof in an aprotic solvent.

### CROSS-REFERENCE TO RELATED APPLICATIONS

This application claims priority to German Patent Application No. 10 2014 206 875.4 filed Apr. 9, 2014 which is herein incorporated by reference.

### BACKGROUND OF THE INVENTION

1. Field of the Invention

The invention relates to a method of cleaning industrial plant components to remove silanes, metal halides and organometallic halides, using a nitrile or amine.

2. Background Art

Many crude industrial products and industrial product mixtures, such as direct synthesis (Müller-Rochow synthesis) mixtures, comprising chlorosilanes and methylchlorosilanes, or the chlorosilane mixtures obtained from hydrochlorination of metallurgical silicon, may comprise silanes, metal halides and organometallic halides, particularly AlCl₃. The silanes present in the crude silanes are separated into pure silanes by multi-stage distillation. The aforementioned impurities in the crude silanes form deposits in the pipes causing problems which may even culminate in blockage of the lines. The lines thus require dismantling and cleaning, e.g. with water, at regular intervals. This method of cleaning has two disadvantages. The first is cost and inconvenience. Disassembly, cleaning and reassembly of lines is costly and very time consuming. The second disadvantage of cleaning with water is the formation, by hydrolysis of chlorosilane residues, metal chlorides, and/or organometallic halides and/or mixtures of metal halides/organometallic halides, of hydrochloric acid which attacks the pipes. Acetonitrile is described as a solvent for aluminum chloride [Zeitschrift für anorganische und allgemeine Chemie. Weinheim: Wiley-VCH, ISSN 0372-7874 Vol. 511 (4. 1984), p. 148].

### SUMMARY OF THE INVENTION

The invention provides a method of cleaning industrial plant components to remove contaminants selected from silanes, metal halides, organometallic halides and mixtures thereof wherein said method comprises treating the plant components with a liquid nitrile or amine or mixtures thereof or with a solution of a nitrile or amine or mixtures thereof in an aprotic solvent.

### DETAILED DESCRIPTION OF THE PREFERRED EMBODIMENT(S)

Contaminants, particularly metal halides, form deposits in plant components. The contaminants are easily dissolved out from the industrial plant components with nitriles or amines. The deposits in the lines are incipiently or fully dissolved and sluiced out. After cleaning, the plant components are dried and brought back on stream. The cleaning residues may simply be sluiced out and properly disposed of, for example by incineration.

Cleaning plant components with nitriles or amines obviates the need for costly and time-consuming disassembly and cleaning with water. The useful life of the plant components is extended since the lines no longer come into contact with acidic water.

The contaminants are in particular metal halides and organometallic halides which form acids on hydrolysis with water, particularly organometallic chlorides. Examples include chlorides and organometallic chlorides of iron, such as FeCl₂, FeCl₃, cobalt, nickel, chromium, titanium, copper, tin, zinc and preferably AlRₓCl₃₋ₓ, where R is an organo or organosilane function, particularly methyl, and x is 0, 1, or 2, particularly AlCl₃.

Preferably employed nitriles are nitriles of mono- or polycarboxylic acids preferably comprising from 2 to 20 carbon atoms, more particularly from 5 to 12 carbon atoms. Preference is given to nitriles of aliphatic saturated monocarboxylic acids, such as acetic, propionic, butyric, valeric and caproic acids and of fatty acids comprising up to 18 carbon atoms. Preference is also given to dinitriles of aliphatic saturated dicarboxylic acids, such as malonic, succinic, glutaric, adipic, pimelic and suberic acids. Preference is given to nitriles having a boiling point of at least 120° C. at 1013 hPa, more particularly at least 150° C. at 1013 hPa.

Particular preference is given to adiponitrile which has a boiling point of 295° C. at 1013 hPa and displays a strong complexing affinity for metal ions due to its two nitrile groups. Adiponitrile is an important intermediate in polyamide production and is thus widely available and inexpensive.

The amines are preferably selected from primary, secondary and tertiary aliphatic and aromatic amines. Polyamines comprising not only primary and secondary but also tertiary amine functions may be employed as well as monoamines.

Preferred monoamines conform to general formula (I)

NR¹R²R³ (I),

where
R¹, R², R³ are H or a monovalent C₁-C₃₀ hydrocarbon radical optionally substituted by substituents selected from F—, Cl—, OH— and OR⁴ where nonadjacent —CH₂— units of the R¹, R², and R³ radicals are optionally substituted by units selected from —C(═O)— and —O—, and
R⁴ is a C₁-C₁₀ alkyl radical.

The monovalent hydrocarbon radicals R¹, R², R³ may be linear, cyclic, branched, aromatic, saturated or unsaturated. The hydrocarbon radicals R¹, R², R³ preferably comprise from 1 to 20 carbon atoms, particular preference being given to alkyl radicals comprising from 1 to 6 carbon atoms, alkylaryl radicals, arylalkyl radicals each and phenyl radicals.

Preferred polyamines conform to general formula (II)

R⁵₂N—(CR⁶₂)ₐ—(NR⁷—(CR⁶₂)_{b})_{c}—NR⁵₂ (II),

where
R⁵, R⁶, R⁷ are H or C₁-C₁₈ hydrocarbon radicals optionally substituted by substituents selected from F—, Cl— and OH— where nonadjacent —CH₂— units of the R⁵, R⁶, and R⁷ radicals are optionally substituted by units selected from —C(═O)— and —O—,
a, b are integers of from 1 to 6, and
c is 0 or an integer of from 1 to 40.
a, b are preferably 2 or 3.
c is preferably an integer of from 1 to 6.
   Preferably, a and b are identical.

Examples of particularly preferred polyamines (A) of general formula (II) include:
diethylenetriamine (H₂N—CH₂CH₂—NH—CH₂CH₂—NH₂),
triethylenetetramine (H₂N—CH₂CH₂—(NH—CH₂CH₂—)₂—NH₂),
tetraethylenepentamine (H₂N—CH₂CH₂—(NH—CH₂CH₂—)₃—NH₂),
pentaethylenehexamine (H₂N—CH₂CH₂—(NH—CH₂CH₂—)₄—NH₂),
hexaethyleneheptamine (H₂N—CH₂CH₂—(NH—CH₂CH₂—)₅—NH₂), and
   mixtures of the abovementioned amines, such as are commercially available as industrial products, for example AMIX1000® (BASF SE).

Examples of further preferred monoamines and polyamines include octylamine, nonylamine, decylamine, undecylamine, dodecylamine (laurylamine), tridecylamine, tridecylamine (isomer mixture), tetradecylamine (myristylamine), pentadecylamine, hexadecylamine (cetylamine), heptadecylamine, octadecylamine (stearylamine), 4-hexylaniline, 4-heptylaniline, 4-octylaniline, 2,6-diisopropylaniline, 4-ethoxyaniline, N-methylaniline, N-ethylaniline, N-propylaniline, N-butylaniline, N-pentylaniline, N-hexylaniline, N-octylaniline, N-cyclohexylaniline, dicyclohexylamine, p-toluidine, indoline, 2-phenylethylamine, 1-phenylethylamine, N-methyldecylamine, benzylamine, N,N-dimethylbenzylamine, 1-methylimidazole, 2-ethylhexylamine, dibutylamine, dihexylamine, di-(2-ethylhexylamine), 3,3′-dimethyl-4,4′-diaminodicyclohexylmethane, 4,4′-diaminodicyclohexylmethane, ditridecylamine (isomer mixture), isophoronediamine, N,N,N′,N′-tetramethyl-1,6-hexanediamine, N,N-dimethylcyclohexylamine, octamethylenediamine, 2,6-xylidine, 4,7,10-trioxatridecane-1,13-diamine, 4,9-dioxadodecane-1,12-diamine, di-(2-methoxyethyl)amine, bis(2-dimethylaminoethyl) ether, Polyetheramin D230® (BASF SE), 2-(diisopropylamino)ethylamine, pentamethyldiethylenetriamine, N-(3-aminopropyl)imidazole, 1,2-dimethylimidazole, 2,2′-dimorpholino diethyl ether, dimethylaminoethoxyethanol, bis(2-dimethylaminoethyl) ether, Lupragen®N600—S-triazine (BASF AG), 1,8-diazabicyclo-5,4,0-undec-7-ene (DBU), 3-(2-aminoethylamino)propylamine, 3-(cyclohexylamino)propylamine, dipropylenetriamine, N4-Amin (N,N′-bis(3-aminopropyl)ethylenediamine), AMIX M (BASF AG) (=high-boiling morpholine derivatives), 1-(2-hydroxyethyl)piperazine, 2-(2-aminoethoxy)ethanol, 3-amino-1-propanol, 3-dimethylaminopropan-1-ol, 4-(2-hydroxyethyl)morpholine, butyldiethanolamine, N-butylethanolamine, N,N-dibutylethanolamine, N,N-diethylethanolamine, dimethylaminoethoxyethanol (Lupragen®N107, BASF AG), methyldiethanolamine, diethanolamine, triethanolamine, diisopropanolamine, triisopropanolamine, 1-vinylimidazole, 1-hexylimidazole, 1-octylimidazole, 1-(2-ethylhexyl)imidazole, and triisooctylamine.

Preference is given to amines having a boiling point of at least 120° C. at 1013 hPa, more particularly at least 150° C. at 1013 hPa.

When solutions of nitriles or amines or mixtures of nitriles and amines in aprotic solvents are employed, preference is given to using solvents or solvent mixtures having a boiling point or boiling range of up to 120° C. at 1013 hPa. Examples of such solvents include ethers, such as dioxane, tetrahydrofuran, diethyl ether, diisopropyl ether, diethylene glycol dimethyl ether; chlorinated hydrocarbons such as dichloromethane, trichloromethane, tetrachloromethane, 1,2-dichloroethane, trichloroethylene; hydrocarbons, such as pentane, n-hexane, hexane isomer mixtures, heptane, octane, solvent naphtha, petroleum ether, benzene, toluene, xylenes; siloxanes, in particular linear dimethylpolysiloxanes comprising trimethylsilyl end groups preferably comprising from 0 to 6 dimethylsiloxane units, or cyclic dimethylpolysiloxanes preferably comprising from 4 to 7 dimethylsiloxane units, for example hexamethyldisiloxane, octamethyltrisiloxane, octamethylcyclotetrasiloxane and decamethylcyclopentasiloxane; ketones, such as acetone, methyl ethyl ketone, diisopropyl ketone, methyl isobutyl ketone (MIBK); esters, such as ethyl acetate, butyl acetate, propyl propionate, ethyl butyrate, ethyl isobutyrate; carbon disulfide and nitrobenzene, or mixtures thereof.

The concentration of the nitriles and/or amines in the aprotic solvents is preferably at least 1 g/l, more preferably at least 5 g/l, and most preferably at least 10 g/l.

The method is preferably carried out at a temperature of from 0° C. to 100° C., more preferably from 15° C. to 30° C., and at a pressure of from 500 hPa to 2000 hPa, more preferably from 900 hPa to 1200 hPa.

One particular embodiment comprises cleaning plant components in which silanes selected from chlorosilanes and methylchlorosilanes are processed. AlRₓCl₃₋ₓ, in particular AlCl₃, is removed from these plant components with high-boiling organochlorosilanes. Acetonitrile is less suitable for these plant components since acetonitrile has a boiling point of 82° C. at 1013 hPa and thus also has an appreciable vapor pressure at room temperature. Its high vapor pressure hampers the use of acetonitrile in pipe cleaning since acetonitrile is flammable. In addition, acetonitrile must not become entrained in silane mixtures of the distillation since its boiling point is very close to that of chlorosilanes and methylchlorosilanes and the acetonitrile would then itself become an impurity. These plant components are cleaned using nitriles alone or in combination with aprotic solvents having a boiling point of at least 120° C. at 1013 hPa. Particular preference is given to adiponitrile.

Examples of plant components include pipes, stirred tanks, tubular reactors, distillation columns and internals and packings thereof, thin film evaporators, falling film evaporators, short path distillation apparatuses including internals thereof, for example wipers in thin film evaporators, but also heat exchangers and vessels, such as tanks and flasks.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of cleaning industrial plant components to remove silane, metal halide, and/or organometallic halide contaminants and mixtures thereof, comprising treating the plant components with a liquid nitrile, amine, or mixture thereof or with a solution of a nitrile, amine or mixture thereof in an aprotic solvent.

2. The method of claim 1 wherein at least one metal halide or organometallic halide is selected from the group consisting of chlorides and organometallic chlorides of iron, cobalt, nickel, chromium, titanium, copper, tin, zinc and aluminum.

3. The method of claim 1, wherein said method comprises employing at least one nitrile of a mono- or polycarboxylic acid comprising from 2 to 20 carbon atoms.

4. The method of claim 2, wherein said method comprises employing at least one nitrile of a mono- or polycarboxylic acid comprising from 2 to 20 carbon atoms.

5. The method of claim 1, wherein said method comprises employing a solution of at least one liquid nitrile or amine or a mixture of at least one nitrile and/or amine in an aprotic solvent selected from the group consisting of ethers, chlorinated hydrocarbons, hydrocarbons, siloxanes, ketones, esters, carbon disulphide, nitrobenzene, and mixtures thereof.

6. The method of claim 2, wherein said method comprises employing a solution of at least one liquid nitrile or amine or a mixture of at least one nitrile and/or amine in an aprotic solvent selected from the group consisting of ethers, chlorinated hydrocarbons, hydrocarbons, siloxanes, ketones, esters, carbon disulphide, nitrobenzene, and mixtures thereof.

7. The method of claim 3, wherein said method comprises employing a solution of at least one liquid nitrile or amine or a mixture of at least one nitrile and/or amine in an aprotic solvent selected from the group consisting of ethers, chlorinated hydrocarbons, hydrocarbons, siloxanes, ketones, esters, carbon disulphide, nitrobenzene, and mixtures thereof.

8. The method of claim 4, wherein said method comprises employing a solution of at least one liquid nitrile or amine or a mixture of at least one nitrile and/or amine in an aprotic solvent selected from the group consisting of ethers, chlorinated hydrocarbons, hydrocarbons, siloxanes, ketones, esters, carbon disulphide, nitrobenzene, and mixtures thereof.

9. The method of claim 1, wherein said method comprises cleaning plant components in which silanes selected from chlorosilanes and methylchlorosilanes are processed, said method comprising removing AlCl₃ and employing nitriles, and optionally also employing aprotic solvents having a boiling point of at least 120° C. at 1013 hPa.

10. The method of claim 2, wherein said method comprises cleaning plant components in which silanes selected from chlorosilanes and methylchlorosilanes are processed, said method comprising removing AlCl₃ and employing nitriles, and optionally also employing aprotic solvents having a boiling point of at least 120° C. at 1013 hPa.

11. The method of claim 3, wherein said method comprises cleaning plant components in which silanes selected from chlorosilanes and methylchlorosilanes are processed, said method comprising removing AlCl₃ and employing nitriles, and optionally aprotic solvents having a boiling point of at least 120° C. at 1013 hPa.

12. The method of claim 1, wherein adiponitrile is employed as a liquid nitrile.

13. The method of claim 2, wherein adiponitrile is employed as a liquid nitrile.

14. The method of claim 3, wherein adiponitrile is employed as a liquid nitrile.

15. The method of claim 1, wherein adiponitrile is employed as a liquid nitrile, in an aprotic solvent.

16. The method of claim 1, wherein the plant components are one or more of pipes, stirred tanks, tubular reactors, distillation columns and internals and packings thereof, thin film evaporators, falling film evaporators, short path distillation apparatuses including internals thereof, heat exchangers and vessels.
